(19) United States
(12) Patent Application Publication
(10) Pub. No.: US 2012/0001747 A1
(43) Pub. Date: Jan. 5, 2012

(54) Electronic drive selector assembly systems and methods

(75) Inventors: Alexander Klatt, Costa Mesa, CA (US); Michael Groene, Rochester, MI (US); Henrik Fisker, Newport Beach, CA (US); Todd George, Chelsea, MI (US); Nikola Stefanov, San Clemente, CA (US); Karl Krohn, Orion, MI (US); Dave Allmond, Traverse City, MI (US)

(73) Assignee: Fisker Automotive, Inc.

(21) Appl. No.: 13/067,870

(22) Filed: Jun. 30, 2011

Related U.S. Application Data
(60) Provisional application No. 61/360,825, filed on Jul. 1, 2010.

(51) Int. Cl. B60Q 1/00

(52) U.S. Cl. 340/456

(57) ABSTRACT

A drive selector assembly arranged on a console of a vehicle for selecting a transmission gear from a plurality of transmission gears includes a housing; a gear selector control arranged in the housing, the gear selector control having a plurality of switches for selecting a transmission gear of the plurality of gears of the vehicle; and at least one visual indicator provided on the console, the at least one visual indicator coupled to the gear selector control for providing a visual indication of the selected transmission gear.

### CROSS-REFERENCE TO RELATED PATENT APPLICATIONS

This application claims priority from U.S. Provisional Application 61/360,825, filed Jul. 1, 2010, incorporated herein by reference in its entirety.

### BACKGROUND

1. Field of the Disclosure

Embodiments of the present invention generally relate to a drive selector for a vehicle, and, in specific embodiments, to an electronic drive selector assembly for a vehicle.

2. Related Art

Vehicles generally include a gear or drive selector operatively connected to the transmission for selecting the transmission gear, such as drive, park, reverse, neutral, and/or the like, for an automatic transmission. For a manual transmission, reverse, first, second, third, fourth, fifth, and/or the like may be selected. The drive selector may be a mechanical lever that is moveable between the various gear positions. However, for an electronic transmission or a “shift by wire” drive selector, the drive selector lever may be static since the driver's intent is communicated electronically. The drive selector lever may be packaged within the vehicle interior so that is it easily accessible to the vehicle operator.

### SUMMARY OF THE DISCLOSURE

Various embodiments relate to a drive selector assembly for a vehicle. The drive selector assembly includes a push button type selector control secured to the vehicle. The drive selector assembly includes a drive selector control switch operatively in communication with a controller for selecting the transmission gear. The drive selector assembly also includes a visual indicator and an audible indicator representing the selected transmission gear. The visual indicator is a LED-activated light (or the like) that is operated in a predetermined pattern corresponding to the selected transmission gear. In various embodiments, the drive selector assembly is provided that is ergonomically accessible. Thus, various embodiments provide a drive selector lever that communicates with a selected gear electronically, and is ergonomically accessible to a vehicle operator and visually communicates intended shift commands to the vehicle operator.

In various embodiments, the drive selector assembly can be readily packed because the control switch is static. In various embodiments, the drive selector is cost effective to implement. In various embodiments, the selected gear input is electronically communicated to a controller, which evaluates the selected gear input and directs the powertrain to take the appropriate action. In various embodiments, the drive selector assembly provides a visual and audible signal that represents the transmission gear selected by the user.

### BRIEF DESCRIPTION OF THE DRAWINGS

FIG. 1 is a perspective view of a drive selector assembly in accordance with an embodiment of the disclosure.

FIG. 2 is a perspective view of a console in accordance with an embodiment of the disclosure.

FIG. 3 is a perspective view of a console in accordance with an embodiment of the disclosure.

FIG. 4 is a perspective view of a console in accordance with an embodiment of the disclosure.

FIG. 5 is an exploded view of a portion of a console in accordance with an embodiment of the disclosure.

FIG. 6 is an exploded view of a portion of a console in accordance with an embodiment of the disclosure.

FIG. 7 is a cut-away view of a drive selector assembly in accordance with an embodiment of the disclosure.

### DETAILED DESCRIPTION

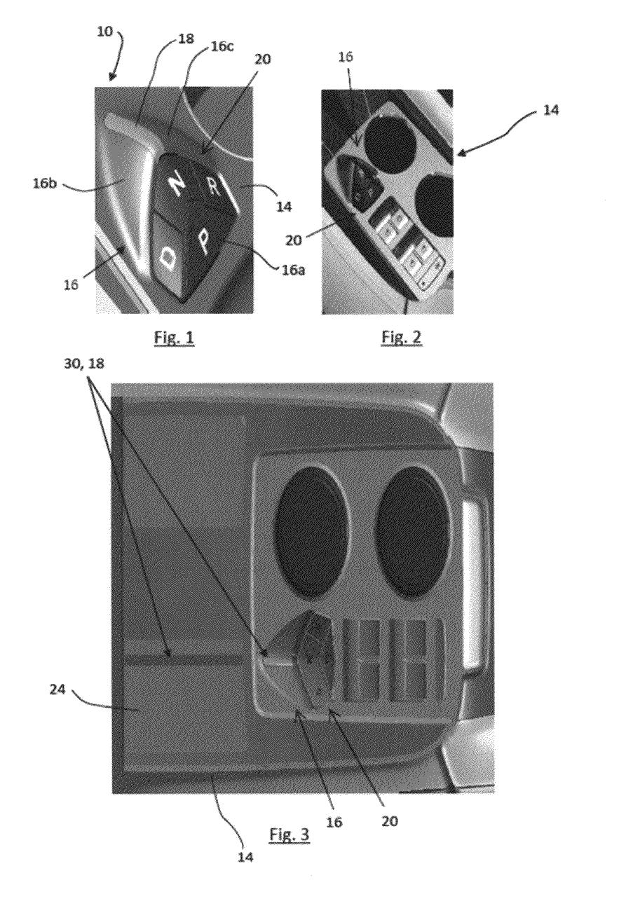

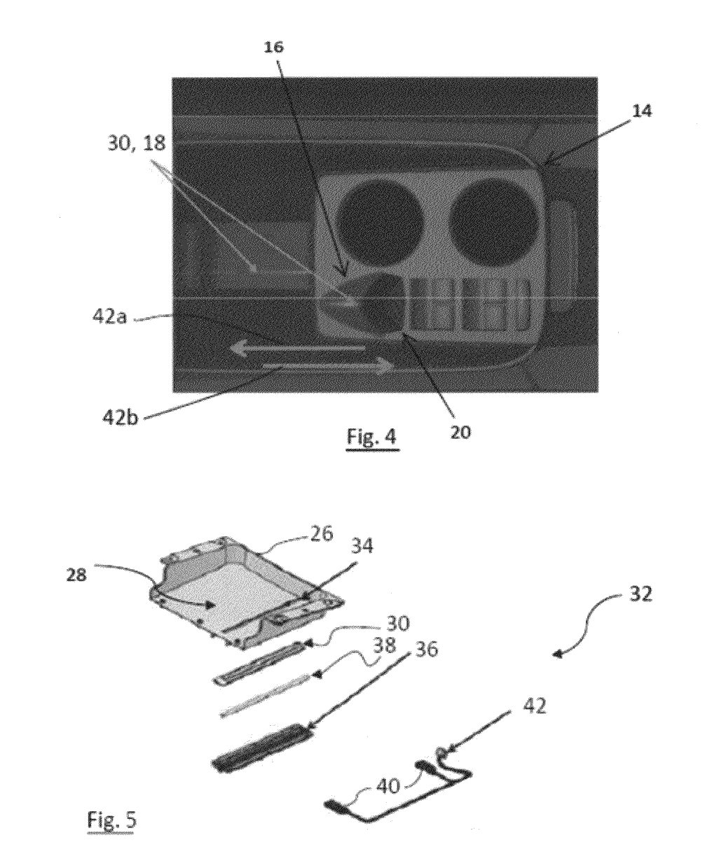

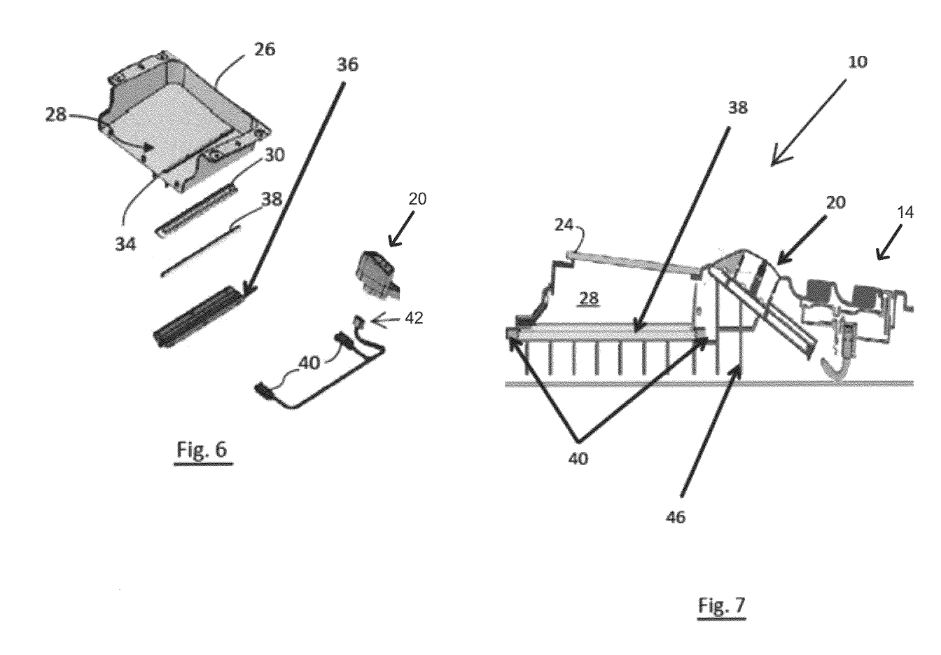

Referring to FIGS. 1-7, a drive selector assembly 10 is provided. The drive selector assembly 10 is utilized with a vehicle, such as a motor vehicle, although it may be adapted for use with any type of vehicle. In some embodiments, the vehicle is a hybrid vehicle.

The drive selector assembly 10 includes a control switch 20. The control switch 20 is secured to the vehicle to be accessible by a vehicle operator. In some embodiments, the control switch 20 is located on a console 14 (e.g., center console or the like). An example of a console 14 is described in (but not limited to) commonly assigned PCT application US2010/020785 and U.S. Provisional Patent Application No. 61/143,970, both of which are incorporated herein by reference in their entirety. In particular embodiments, the console 14 may be any area ergonomically reachable by the operator of the vehicle, such as the instrument panel or the like. The control switch 20 is operatively in communication with one or more systems of the vehicle, such as (but not limited to the) a transmission system, an ignition system, a brake system, a controller system, and/or similar systems, for instance, in a manner described in (but not limited to) the disclosure.

The control switch 20 includes an outer housing 16. The outer housing 16 may be integrally formed as part of the console 14. In some embodiments, the control switch 20 is static or fixed in place relative to the outer housing 16 and/or the console 14. In particular embodiments, the control switch 20 is positioned within the outer housing 16. The outer housing 16 may assume various shapes depending on factors such as packaging or the like. In some embodiments, the outer housing 16 is configured to have a pyramidal shape, with a vertically oriented face 16a and a horizontally oriented base (not shown) and two diverging side faces 16b, 16c joined at an upper end. At least a portion of the outer housing 16, for instance between the upper ends of the side faces 16b, 16c, may be a translucent material that allows for light from a first light indicator 18 to shine through the translucent material. In other embodiments, the outer housing 16 may define at least one opening through which light from the first light indicator 18 may shine.

In various embodiments, the control switch 20 is a drive selector control switch that is operatively in communication with the vehicle transmission system and transfers information from the vehicle operator regarding a desired operating condition for the vehicle to the transmission system of the vehicle. Examples of operating conditions for an automatic transmission include, for example, park, neutral, reverse, drive, and/or the like. Similarly, examples of operating conditions for a manual transmission include reverse, first gear, second gear, third gear, fourth gear, fifth gear, and/or the like. In some embodiments, the transmission may be an electronically controlled transmission system. In other embodiments, the transmission system may be mechanically controlled system. In yet other embodiments, the transmission system may be a combination of both.

In particular embodiments, the control switch 20 is a displaceable switch (or other type of switch) supported within the outer housing 16. In some embodiments, the control switch 20 is a push button-type switch. In other embodiments, the control switch 20 may be any suitable type of switch, such as (but not limited to) a slideable-type, dial-type, rocker-type switch, touch-sensitive switch, or the like. In particular embodiments, the control switch 20 may be a three-position momentary rocker switch (e.g., FIG. 1). In various embodiments, the control switch 20 (and/or associated electronics) is configured such that only one switch position (or corresponding switch signal) may be selected at a time.

In various embodiments, the control switch 20 may be part of a display screen (e.g., LCD, LED, etc.) displaying switches that can be selected via touch, a cursor, a roller, a knob, corresponding buttons, and/or the like. In some embodiments, the appearance of the display screen may change like the first light indicator 18 and/or the second light indicator 30, as discussed in the disclosure. In some embodiments, the display screen is supported by the console 14. In other embodiments, the display screen is the display screen used for other functions (e.g., navigation, audio system, etc.).

In some embodiments, the control switch 20 includes a home or park position on or near the front wall 16a, neutral position on the upper wall (adjacent the left wall 16b and the right wall 16c), a drive position on or near the left wall 16b, and a reverse position on or near the right wall 16c. In particular embodiments, at least a portion of a switch corresponding to the neutral position is at least partially (or fully) arranged between the switches corresponding to the drive position and the reverse position. Because such embodiments provide a definite differentiation of function (e.g., between drive and reverse), additional safety measures are afforded. It should be noted that the switches (or the like) of the control switch 20 may be arranged in any suitable configuration and/or include additional or fewer switches as desired. For instance, first gear, second gear, third gear, fourth gear, and/or the like may be arranged in a clockwise, counter-clockwise, linear, and/or other suitable arrangement. In some embodiments, one or more of the switches of the control switch 20 may have a light indicator (e.g., LED) to facilitate selection thereof, such as, in a low-light situation. In further embodiments, the light indicators may function like the first light indicator 18 and/or the second light indicator 30, as discussed in the disclosure. In some embodiments, the switches of the gear indicator control may have protrusions or provide other tactile feedback to facilitate selection.

At least a portion of an upper portion 24 of the console 14 is made of a translucent material for a second light indicator 30 to shine through the translucent material. In other embodiments, the upper portion 24 includes one or more openings for the second light indicator 30 to shine through the one or more openings. The console 14 includes a lower portion having a recess 34 in which the second light indicator 30 is arranged. The upper portion 24 and the lower portion 26 of the console 14 may define an interior space 28 in which the second light indicator 30 is arranged. In particular embodiments, the interior space 28 may form a storage compartment or the like. The lower portion 26 of the console 14 is arranged to be (at least partially) below or sufficiently near the upper portion 24 of the console 14 to allow light emitted from the second light indicator 30 to shine through the translucent material. The lower portion 26 is supported on a base member 46. In particular embodiments, the base member 46 may be a rib cartridge or the like for absorbing a force from an impact or the like.

The second light indicator 30 has a predetermined shape, such as rectangular shape or the like, and is made of a translucent material through which a light may shine. In other embodiments, the second light indicator 30 may include one or more openings through which a light may shine. In various embodiments, the second light indicator 30 and the first light indicator 18 are in alignment (e.g., FIG. 3). In other embodiments, the second light indicator 30 and the first light indicator 18 are not in alignment. For example, the second light indicator 30 and the first light indicator 18 may extend in a same direction, but be laterally offset from each other. In particular embodiments, the second light indicator 30 is continuous with the first light indicator 18. Such embodiments provide an appearance that light emitted by the first light indicator 18 is substantially continuous with light emitted by the second light indicator 30.

The drive selector assembly 10 includes a light assembly 32, which may be secured to the console 14. In various embodiments, the light assembly 32 includes a light tube housing 36 that is secured to an outer surface of the lower console 26, corresponding to the recess 34. A light tube 38 is disposed in the light tube housing 36. In some embodiments, the light tube 38 is cylindrical member having a central bore. In other embodiments, the light tube 38 may have any suitable shape. The light tube 38 is fabricated from a reflective material. In other embodiments, the light tube 38 may be made of any suitable material.

At least one lighting source (or light engine) 40 is supported by the light tube 38 in a predetermined position. In some embodiments, the lighting source 40 is an LED light or other suitable light. A lighting source 40 is located at each of a first end and a second end of the light tube 38. The lighting sources 40 are operatively connected to a controller 42. The controller 42 operates the activation (or changes a state) of the lighting sources 40 to change an appearance (e.g., intensity, brightness, frequency, color, pattern, movement, and/or the like) of the lighting sources 40 based on a gear (e.g., drive, neutral, first, second, etc.) selected by the control switch 20. Thus, for example, the intensity of each lighting source 40 and timing of activation between each lighting source 40 may be selected to provide a predetermined effect based on a gear selection. In some embodiments, at least one of the lighting sources 40 may be arranged to be (or be part of) the second light indicator 30 and at least one other of the lighting sources 40 may be arranged to be (or be part of) the first light indicator 18. For instance, in particular embodiments, the light tube 38 may extend from the first light indicator 18 to the second light indicator 30 with (at least) a first lighting source 40 at the first light indicator 18 and (at least) a second lighting source 40 at the second light indicator 30.

In some embodiments, movement of an indicator light signal (e.g., 42a, 42b) may be provided by varying timing, intensity, and/or the like of the LED lights to give an illusion or appearance of a moving light. For example, by varying the timing, intensity, and/or the like of the indicator light signal a “dark spot” will move within the light tube 38. The movement of the light signal is conveyed through one or both of the first light indicator 18 and second light indicator 30. The light may be a predetermined color, such as green or the like. The light colors could also be varied depending on the selected gear, for instance, green for drive, red for reverse, orange for neutral, and/or the like. Such embodiments may provide further notice to the operator of the vehicle that the vehicle is in a given transmission state (e.g., forward versus reverse versus park).

In some embodiments, the drive selector assembly 10 may be coupled to an audible signal indicator (not shown) that provides a predetermined sound or speech when a corresponding gear is selected. In other embodiments, the drive selector assembly 10 may provide a sound through a speaker system of the vehicle or the like. Such embodiments may provide further notice to the operator of the vehicle that the vehicle is in a given transmission state (e.g., park versus drive versus reverse). In particular embodiments, an audible signal may be repeated at a pre-defined interval while the gear is selected. For instance, while in a “reverse” position, the audible signal indicator may continue to beep every two seconds until a different gear is selected.

In operation, the lighting sources 40 are selectively activated (or otherwise have their states changed) in response to a gear selection by the control switch 20 to indicate which gear is selected. For example, in a “park” or “neutral” position, the lighting sources 40 may be selectively activated to provide a pulsing effect to the operator through the first light indicator 18 and/or the second light indicator 30. In a “forward” or “drive” position, the lighting sources 40 may be selectively activated to provide a first movement effect 42a (e.g., toward a front of the vehicle) to the operator through the first light indicator 18 and/or the second light indicator 30. In a “rearward” or “reverse” position, the lighting sources 40 may be selectively activated to provide a second movement effect 42b (e.g., toward a rear of the vehicle) to the vehicle operator through the first light indicator 18 and/or the second light indicator 30. Such embodiments may provide further notice to the operator of the vehicle that the vehicle is in a given transmission state (e.g., forward versus reverse versus park).

In various embodiments, once the visible indicator indicates the current gear selection, the lighting sources 40 may maintain the visible indicator as long as the current gear is selected. In some embodiments, the lighting sources 40 may flash with a higher intensity when initially selected. In some embodiments, the lighting sources 40 may remain visible for a predetermined amount of time after gear selection, and then change to a different appearance. For instance, the lighting sources 40 may provide a first appearance (e.g., brightness, pattern, color, and/or the like) for five minutes (or other amount of time), and then change to a second appearance that is less than the first intensity or shut-off until the next selection of a gear. As another example, the lighting sources 40 may provide a first appearance (e.g., brightness, pattern, color, and/or the like) until the vehicle reaches a certain speed at which point the lighting sources 40 change to a different intensity.

In some embodiments, the appearance of the lighting sources 40 may change based on one or more various additional factors, such as but not limited to, speed of the vehicle, volume of the audio system (e.g., radio) of the vehicle, time of day (e.g., night or day), whether the headlights are on or off, proximity to destination or other point of interested (e.g., as determined by a GPS circuit or the like), amount of time/distance traveled, and/or the like. For instance, when in the “drive” position, the brightness (or the like) of the lighting sources 40 may increase as a speed of the vehicle increases and decrease as a speed of the vehicle decreases. As another example, during the day (e.g., as detected by a light sensor or the like, nighttime headlights are determined to be off, or the like), the appearance of the lighting sources 40 may be different from at night.

In some embodiments, each switch of the control switch 20 corresponds to a different state of the lighting sources 40 such that selection of one of the switches (and the corresponding gear) causes the lighting sources 40 to change to a state corresponding to the selected one of the switches. For example, selecting a “first gear” switch to place the vehicle in first gear may cause the first light indicator 18 and/or the second light indicator 30 to provide a green light that is moving forward. Subsequent selection of a “second gear” switch to the place the vehicle in second gear may cause the first light indicator 18 and/or the second light indicator 30 to change from the green light that is moving forward to a blue light that is moving forward. In other embodiments, some of the switches may be a “gear up” and a “gear down” switch to increase and decrease the current gear selection of the vehicle. For example, when the vehicle is in first gear, actuation of the “gear up” switch may place the vehicle in second gear and cause the first light indicator 18 and/or the second light indicator 30 to change accordingly (e.g., to change from the green light that is moving forward to a blue light that is moving forward).

In some embodiments, the vehicle may include other portions in communication with one or more of the first light indicator 18 and the second light indicator 30 to display a current drive (gear) selection. For instance, the dashboard and/or the dashboard console of the vehicle may include some indicator operating along with the first light indicator 18 and the second light indicator 30. For example, appearance of a portion of the dashboard, such as buttons of the radio, may change similar to the first light indicator 18 and/or the second light indicator 30. For example, if the first light indicator 18 and the second light indicator 30 are flashing green when in the “drive” position, LEDs or the like in radio may flash green accordingly.

According to various embodiments, the visual indications provided by the first light indicator 18 and/or the second light indicator 30, and optionally any additional light indicators and/or audible indicators or the like, provide additional safety measures to the operator of the vehicle because the operator is more able to visually (and/or audibly) ascertain that the vehicle is in a given transmission state. Thus, for example, when selecting the drive position, the presence of a green light moving forward (e.g., 42b in FIG. 4) provides an additional notice to the operator that the vehicle is in a state for forward motion, as opposed to a reverse motion or no motion at all.

An example of a gearshift assembly in conjunction with the drive selector assembly 10 is described in (but not limited to) commonly assigned U.S. Provisional App. Ser. No. 61/328,861, which is incorporated herein by reference in its entirety. In various embodiments, the gearshift assembly is coupled to (or includes) the control switch 20 to transmit a signal (from the control switch 20) indicating a selected gear to a shifter module. The shifter module is a controller that detects the selected gear and is communication with other components within the transmission system and other related systems.

In operation, the vehicle operator actuates the control switch 20 to select a desired transmission operation, such as park, reverse, neutral, drive, and/or the like. A plurality of signals is transmitted from the control switch 20, for example via the gearshift assembly, to the shifter module, which analyzes the signals and transmits a signal to a hybrid control unit (HCU) or the like. The HCU analyzes the signal from the shifter module and other vehicle inputs and determines if and when to shift gears. The transmission system implements an action, for instance to change the transmission operation of the vehicle, based on the determination.

The embodiments disclosed herein are to be considered in all respects as illustrative, and not restrictive of the invention. The present invention is in no way limited to the embodiments described above. Various modifications and changes may be made to the embodiments without departing from the spirit and scope of the invention. The scope of the invention is indicated by the attached claims, rather than the embodiments. Various modifications and changes that come within the meaning and range of equivalency of the claims are intended to be within the scope of the invention.

What is claimed is:

1. A drive selector assembly arranged on a console of a vehicle for selecting a transmission gear from a plurality of transmission gears, the drive selector assembly comprising:
a housing;
a gear selector control supported by the housing, the gear selector control having a plurality of switches for selecting a transmission gear of the plurality of gears of the vehicle; and
at least one visual indicator provided on the console, the at least one visual indicator coupled to the gear selector control for providing a visual indication of the selected transmission gear.

2. The assembly of claim 1, the assembly further comprising:
an audible indicator coupled to the gear selector control for providing an audible indication of the selected transmission gear.

3. The assembly of claim 1, the at least one visual indicator comprising a first light indicator and a second light indicator, wherein the first light indicator is supported by the housing and the second light indicator is remote from the housing.

4. The assembly of claim 3, wherein the second light indicator is on the console of the vehicle.

5. The assembly of claim 4, the at least one visual indicator further comprising a third light indicator, the third light indicator remote from the console of the vehicle.

6. The assembly of claim 3, wherein the first light indicator and the second light indicator are in alignment with each other.

7. The assembly of claim 6, the first light indicator having a longitudinal dimension aligned with a longitudinal dimension of the second light indicator.

8. The assembly of claim 3, wherein the first light indicator and the second light indicator are adjacent each other.

9. The assembly of claim 3, wherein the second indicator is substantially larger than the first light indicator.

10. The assembly of claim 1, the assembly further comprising:
a controller configured to change a state of the at least one visual indicator in response to the selection of the transmission gear.

11. The assembly of claim 10, wherein the change in the state is a change in at least one of color, intensity, brightness, pattern, movement, and frequency.

12. The assembly of claim 1, wherein the at least one visual indicator is configured to provide a different visual indication for each of the plurality of gears.

13. The assembly of claim 1, wherein the at least one visual indicator is configured to provide a different visual indication for each of the plurality of switches.

14. The assembly of claim 1, wherein the gear selector control is coupled to a transmission control for changing the transmission gear of the vehicle based on the selected transmission gear.

15. The assembly of claim 1, wherein the at least one visual indicator comprises at least one LED.

16. The assembly of claim 1, wherein the at least one visual indicator is operated in a predetermined manner corresponding to the selected transmission gear.

17. The assembly of claim 1, wherein the at least one visual indicator is operated in a predetermined manner corresponding to the selected switch.

18. The assembly of claim 1, wherein the at least one visual indicator provides a light signal that moves relative to the housing based on the selected transmission gear.

19. The assembly of claim 18, wherein the light signal moves in a first direction when the selected transmission gear corresponds to drive.

20. The assembly of claim 19, wherein the at least one visual indicator provides a light signal moving in a second direction, different from the first direction, when the selected transmission gear corresponds to reverse.

21. The assembly of claim 18, wherein the light signal moves in a same direction as a direction of movement of the vehicle while in the selected transmission gear.

22. The assembly of claim 1, wherein the console is arranged to one of a left side or a right side of an operator of the vehicle.

23. The assembly of claim 1, wherein, after providing the visual indication of the selected transmission gear, the at least one visual indicator is configured to change the visual indication based on a predetermined event other than a selection of a transmission gear.

24. A method of manufacturing a drive selector assembly arranged on a console of a vehicle for selecting a transmission gear from a plurality of transmission gears, the method comprising:
providing a housing;
supporting a gear selector control by the housing, the gear selector control having a plurality of switches for selecting a transmission gear of the plurality of gears of the vehicle; and
providing at least one visual indicator on the console, the at least one visual indicator coupled to the gear selector control for providing a visual indication of the selected transmission gear.
